(19) United States
(12) Patent Application Publication
(10) Pub. No.: US 2012/0061241 A1
(43) Pub. Date: Mar. 15, 2012

(54) APPARATUS AND ASSOCIATED METHODS

(75) Inventors: Georgios Lentaris, Cambridge (GB); Richard White, Huntingdon (GB)

(73) Assignee: NOKIA CORPORATION, Espoo (FI)

(21) Appl. No.: 12/882,946

(22) Filed: Sep. 15, 2010

(51) Int. Cl. C25D 13/00; H01B 1/00; B82Y 30/00

(52) U.S. Cl. 204/477; 252/500; 977/762; 977/902

(57) ABSTRACT

A method of deposition, the method comprising:
providing an electrode pair and a fluid medium,
the electrode pair comprising first and second electrodes configured to generate an alternating electric field therebetween,
the fluid medium comprising a plurality of different types of particle dispersed therein; and
setting one or more parameters of the alternating electric field to attract at least one type of particle from the fluid medium towards the electrode pair and deposit said at least one type of particle.

### TECHNICAL FIELD

The present disclosure relates to the field of dielectrophoresis, associated methods and apparatus, and in particular concerns the selective deposition and alignment of particles from a fluid medium. Certain disclosed example aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs).

The portable electronic devices/apparatus according to one or more disclosed example aspects/embodiments may provide one or more audio/text/video communication functions (e.g. tele-communication, video-communication, and/or text transmission, Short Message Service (SMS)/Multimedia Message Service (MMS)/emailing functions, interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Nanotechnology is fast moving from the study of fundamental phenomena associated with individual nanostructures towards the realization of systems built around active and functional nanoscale components. Furthermore, it is highly likely that new manufacturing technologies built around the self- or directed-assembly of nanoscale components will become prominent in the future and will complement the traditional microfabrication processes that are prevalent today.

Added functionality can be achieved when systems of different nanomaterials are combined on a single chip, one example being context-aware sensing systems. Context awareness is the ability of a device to sense one or more stimuli from its surrounding environment (its context) in order to tailor its behaviour/performance accordingly. For example, a device may comprise a temperature sensor to detect the temperature of the surrounding environment. In the event that the temperature exceeds a critical value, the device may be configured to activate an internal fan to cool the electrical components. The device may also comprise a light sensor to detect the number of incident photons. In this case, the device may be configured to switch on a backlight to illuminate a display screen when the number of photons drops below a particular value. Aside from temperature and light, modern devices are capable of detecting a large range of different stimuli. Some examples include the presence and/or concentration of chemical or biological species, pH, pressure, location, and orientation. In order to detect multiple stimuli at the same time, such devices require a “sensing layer” comprising a plurality of different sensing elements. For accurate detection, different sensing elements may have distinct, but overlapping, sensitivity profiles for each stimuli.

One way to incorporate the different sensitivities is by using an array of nanowire sensing elements made from different materials. One problem with this, however, is the complex fabrication involved in forming the sensor array. With top-down CMOS (complementary metal-oxide-semiconductor) processing, each additional material requires increasingly expensive lithographic procedures either pre- or proceeded by a material deposition step. Therefore, the greater the number of additional materials, the more costly the fabrication.

Directed nanowire assembly methods to date have either concentrated on the deposition of a film of aligned nanowires of a single material (e.g. using shear deposition or Langmuir-Blodgett methods), or the positioning of nanowires of a single material out of suspension (e.g. using dielectrophoresis). In order to deposit nanowires of different materials on a single wafer using these techniques, a completely separate alignment process is required for each material. This adds substantial time and cost to the process and is therefore inefficient.

The apparatus and associated methods disclosed herein may or may not address one or more of these issues.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

According to a first aspect, there is provided a method of deposition, the method comprising:
providing an electrode pair and a fluid medium,
the electrode pair comprising first and second electrodes configured to generate an alternating electric field therebetween,
the fluid medium comprising a plurality of different types of particle dispersed therein; and
setting one or more parameters of the alternating electric field to attract at least one type of particle from the fluid medium towards the electrode pair and deposit said at least one type of particle.

The steps of any method disclosed herein do not have to be performed in the exact order disclosed, unless explicitly stated.

The act of depositing the particles may be taken to include alignment of the particles with the electric field generated by the electrode pair.

The at least one type of particle may be deposited between the first and second electrodes of the electrode pair, and may be deposited such that it is in direct physical contact with one or both of the first and second electrodes.

The one or more parameters of electric field may be one or both of frequency and amplitude.

The method may comprise setting the one or more parameters of the alternating electric field to attract more than one type of particle for deposition. The method may comprise setting the one or more parameters of the alternating electric field to control the probability of depositing each type of particle.

The method may comprise providing multiple electrode pairs configured for individual control. The method may further comprise setting the one or more respective electric field parameters associated with at least two electrode pairs to deposit a different type of particle between the first and second electrodes of each of the at least two electrode pairs. The method may comprise providing the multiple electrode pairs in a cross-bar configuration.

The method may comprise providing multiple electrode pairs configured for simultaneous control as an electrode unit. The method may comprise setting the one or more electric field parameters associated with the electrode unit to deposit the same type of particle between the first and second electrodes of each electrode pair.

The method may comprise depositing a layer of material on top of the deposited particles. Two or more (or each) types of particle may each comprise a different material. The method may comprise removing the electrode pair after deposition of the at least one type of particle. Removal of the electrode pair may be performed using a selective etching process (either wet or dry etching). The method may comprise removing the fluid medium following deposition of the desired particles, and subsequently removing fluid residue left on the deposited particles by some post-deposition treatment, such as oxygen plasma de-scumming.

The particles may be sensing elements. Any reference to a sensing element being suitable for “sensing” a particular stimulus from the surrounding environment may be taken to mean that the sensing element is “influenced or activated by” said stimulus.

Each type of sensing element may be suitable for sensing a respective stimulus from the surrounding environment when electrically connected between the first and second electrodes of the electrode pair. The at least one type of sensing element may be deposited such that it is electrically connected between the first and second electrodes of the electrode pair.

Each type of sensing element may be suitable for sensing one or more stimuli from the surrounding environment. Two or more types of sensing element may be suitable for sensing the same stimulus. At least two (or each) of the two or more types of sensing element may have a distinct sensitivity profile for said stimulus. The sensitivity profile of at least one of the two or more types of sensing element may overlap with the sensitivity profile of another of the two or more types of sensing element.

At least one (or each) type of sensing element may be suitable for sensing one or more of the following stimuli: the presence and/or concentration of a chemical species, the presence and/or concentration of a biological species, temperature, pH, and electromagnetic radiation.

The first and second electrodes may be source and drain electrodes, respectively. The first and second electrodes may be electrically connected to one or more sensing elements such that an electrical current may flow from the first electrode through the sensing elements to the second electrode when a potential difference is applied across the first and second electrodes. Electrical connectors may be electrically connected to the first and second electrodes to apply the potential difference. The electrical connectors may be removably connected to the first and second electrodes. The first and second electrodes may be electrically insulated from the fluid medium. The sensor elements may be configured such that their conductance or other electrical property varies on interaction with the stimuli.

The particles may be formed from an intrinsic or doped semiconducting material. The semiconducting material may be a p-type or n-type semiconducting material. The particles may comprise one or more of the following materials: zinc oxide, silicon, vanadium oxide, carbon, and gallium nitride. The particles may comprise electrically conducting, semiconducting or insulating material. The electrically conducting material may comprise a metal. The particles may comprise a combination of electrically conducting, semiconducting and insulating material (e.g. particles composed of regions of different doping levels).

The particles may comprise biological molecules (such as DNA). In this case, the fluid medium may be configured to exhibit approximately physiological conditions. For example, the fluid medium may comprise DNA molecules in a HEPES/NaOH buffer solution (where HEPES is 4-(2-hydroxyethyl)-1-piperazineethanesulfonic acid).

The particles may comprise nanowires, nanotubes, or any other type of nanoparticle. The nanowires may be hollow/solid tubes. The nanowires, nanotubes and nanoparticles may be carbon nanowires, carbon nanotubes and carbon nanoparticles, respectively. The dimensions of each particle may vary from the macroscale (e.g. cm or mm) to the microscale (e.g. μm) or nanoscale (e.g. nm).

The electrodes/electrode units may be fabricated on a supporting substrate. The supporting substrate may be formed from an intrinsic or doped p-type or n-type semiconducting material, and may comprise silicon, gallium arsenide, gallium nitride or gallium phosphide. The electrodes/electrode units may be fabricated using any standard lithographic and/or deposition processes. The electrodes and fluid medium may form part of a kit.

The at least one type of deposited particle may form part of an apparatus. The apparatus may be one or more of the following: a sensor apparatus, a portable electronic device, and a module for a portable electronic device.

The apparatus may form part of an intelligent context-aware sensor. The apparatus may form part of a field-effect transistor. The field-effect transistor may be a nanowire field-effect transistor. The apparatus may comprise a plurality of nanowires on a supporting substrate. The apparatus may comprise one or more arrays of nanowires on a supporting substrate. Advantageously, the respective arrays may be configured to be spaced apart from one another on the supporting substrate such that the apparatus is able to perform multiplexed sensing experiments. The apparatus may be integrated within a microfluidic system.

The apparatus may comprise a processor configured to process the code of the computer program. The processor may be a microprocessor, including an Application Specific Integrated Circuit (ASIC).

According to a further aspect, there is provided a fluid medium comprising a plurality of different types of particle dispersed therein, wherein each type of particle is suitable for deposition under particular electric field conditions of an alternating electric field generated between first and second electrodes of an electrode pair.

The fluid medium may comprise one or more particles of each type. The specific choice of fluid medium may depend on the types of particle. The fluid medium may be an organic solvent, and may comprise one or more of the following: an alcohol, an alkane and a ketone. More specifically, the fluid medium may comprise one or more of the following: deionised water, methanol, ethanol, isopropanol, and benzene. The combination of the fluid medium and dispersed particles may be referred to as a “suspension”. The dispersed particles may be referred to as “suspensoids”.

According to a further aspect, there is provided a computer program for controlling deposition using an electrode pair and a fluid medium,
the electrode pair comprising first and second electrodes configured to generate an alternating electric field therebetween,
the fluid medium comprising a plurality of different types of particle dispersed therein,
the computer program comprising code configured to set one or more parameters of the alternating electric field to attract at least one type of particle from the fluid medium towards the electrode pair and deposit said at least one type of particle.

According to another aspect, there is provided a method of making an apparatus, the method comprising:
providing an electrode pair and a fluid medium,
the electrode pair comprising first and second electrodes configured to generate an alternating electric field therebetween,
the fluid medium comprising a plurality of different types of sensing element dispersed therein, each type of sensing element configured to sense a respective stimulus from the surrounding environment when electrically connected between the first and second electrodes of the electrode pair; and
setting one or more parameters of the alternating electric field to attract at least one type of sensing element from the fluid medium towards the electrode pair and deposit the at least one type of sensing element such that it is electrically connected between the first and second electrodes of the electrode pair.

The phrase “configured to sense”, as used above, relates to the type of sensing element, and may be taken to mean that the sensing element has particular characteristics or properties that render it suitable for sensing one or more stimuli when electrically connected between the first and second electrodes of the electrode pair.

The method may comprise setting the one or more parameters of the alternating electric field to attract more than one type of sensing element for deposition. The method may comprise setting the one or more parameters of the alternating electric field to control the probability of depositing each type of sensing element.

The method may comprise providing multiple electrode pairs configured for individual control, and setting the electric field parameters of at least two electrode pairs to deposit the same type or a different type of sensing element between the first and second electrodes of each of the at least two electrode pairs. The method may comprise providing the multiple electrode pairs in a cross-bar configuration.

The method may comprise providing multiple electrode pairs configured for simultaneous control as an electrode unit, and setting the electric field parameters of the electrode unit to deposit the same type of sensing element between the first and second electrodes of each electrode pair.

The method may comprise depositing a layer of material on top of the deposited sensing elements to hold the sensing elements in place between the first and second electrodes of the electrode pair.

Two or more (or each) types of sensing element may each comprise a different material. The sensing elements may comprise nanowires or nanotubes. The fluid medium may comprise one or more sensing elements of each type. The sensing elements may be formed from an intrinsic or doped semiconducting material. The semiconducting material may be a p-type or n-type semiconducting material. The sensing elements may comprise one or more of the following materials: zinc oxide, silicon, vanadium oxide, carbon, and gallium nitride.

The sensing elements may comprise nanowires, nanotubes, or any other type of nanoparticle capable of being deposited and electrically connected between the first and second electrodes. The nanowires may be hollow/solid tubes. The nanowires, nanotubes and nanoparticles may be carbon nanowires, carbon nanotubes and carbon nanoparticles, respectively. The dimensions of each sensing element may vary from the macroscale (e.g. cm or mm) to the microscale (e.g. μm) or nanoscale (e.g. nm).

According to a further aspect, there is provided a fluid medium for use in making an apparatus, the fluid medium comprising a plurality of different types of sensing element dispersed therein, each type of sensing element configured to sense a respective stimulus from the surrounding environment when deposited for electrical connection between the first and second electrodes of an electrode pair by an alternating electric field generated between said first and second electrodes.

According to a further aspect, there is provided a computer program for making an apparatus using an electrode pair and a fluid medium,
the electrode pair comprising first and second electrodes configured to generate an alternating electric field therebetween,
the fluid medium comprising a plurality of different types of sensing element dispersed therein, each type of sensing element configured to sense a respective stimulus from the surrounding environment when electrically connected between the first and second electrodes of the electrode pair,
the computer program comprising code configured to set one or more parameters of the alternating electric field to attract at least one type of sensing element from the fluid medium towards the electrode pair and deposit the at least one type of sensing element such that it is electrically connected between the first and second electrodes of the electrode pair.

The present disclosure includes one or more corresponding aspects, example embodiments or features in isolation or in various combinations whether or not specifically stated (including claimed) in that combination or in isolation. Corresponding means for performing one or more of the discussed functions are also within the present disclosure.

Corresponding computer programs for implementing one or more of the methods disclosed are also within the present disclosure and encompassed by one or more of the described example embodiments.

The above summary is intended to be merely exemplary and non-limiting.

### BRIEF DESCRIPTION OF THE FIGURES

A description is now given, by way of example only, with reference to the accompanying drawings, in which:—

FIG. 1 shows a planar field effect transistor (prior art);

FIG. 2 shows a nanowire field effect transistor (prior art);

FIG. 3 shows a typical conductance versus time plot for a nanowire sensor (prior art);

FIG. 4a shows a particle subjected to dielectrophoretic force (prior art);

FIG. 4b shows a particle subjected to dielectrophoretic force when the electric field is reversed (prior art);

FIG. 5 shows how the Clausius-Mossotti factor varies with the frequency of applied field for different solvents (prior art);

FIG. 6 shows how the Clausius-Mossotti factor varies with the frequency of applied field for different nanowire materials (prior art);

FIG. 7 shows an apparatus comprising one electrode pair (according to one embodiment of the present invention);

FIG. 8 shows how the theoretical and experimental nanowire deposition/alignment yields vary with the frequency of applied field (according to one embodiment of the present invention);

FIG. 9 shows how the deposition/alignment yields of vanadium oxide and zinc oxide nanowires vary with the frequency of applied field (according to one embodiment of the present invention);

FIG. 10 shows an apparatus comprising multiple electrode pairs configured for individual control (according to one embodiment of the present invention);

FIG. 11 shows how the proportion of each type of nanowire deposited/aligned on the substrate varies with the frequency of applied field (according to one embodiment of the present invention);

FIG. 12 shows an apparatus comprising multiple electrode pairs configured for simultaneous control (according to one embodiment of the present invention);

FIG. 13 shows an apparatus comprising multiple electrode pairs in a crossbar configuration (according to one embodiment of the present invention);

FIG. 14 shows a device comprising the apparatus described herein (according to one embodiment of the present invention);

FIG. 15 shows a method of making the apparatus described herein (according to one embodiment of the present invention); and

FIG. 16 shows a computer readable medium providing a program for making the apparatus described herein (according to one embodiment of the present invention).

### DESCRIPTION OF SPECIFIC ASPECTS/EMBODIMENTS

As mentioned above, the present disclosure relates to a method of deposition, a fluid medium for use in deposition, and a computer program for controlling deposition. Whilst the following description has been directed specifically towards sensing applications, a person skilled in the art will appreciate that the method, fluid medium and computer program described herein could be applied to any application that requires the deposition of a particular type of material from a single feedstock solution comprising a plurality of different types of material. In this respect, the terms “sensing element”, “nanowire”, and “particle” as used throughout the description are interchangeable. Consequently, the fluid medium may be a suspension of any type of particle (even biological material), and is not necessarily limited to particles that could serve as sensing elements.

Furthermore, whilst the electrodes play an active role in the deposition/alignment of the particles, they may or may not play an active role thereafter. For example, where the particles are sensing elements, the electrodes may be used during subsequent sensing experiments (as will be discussed later in the description). On the other hand, if the aim of the deposition/alignment process is simply to deposit a layer of material on top of a supporting substrate, the electrodes may be redundant after deposition/alignment. In this case, it may be preferable to remove the electrodes after deposition/alignment, possibly using a selective etching process.

Central to detection is the signal transduction associated with selective recognition of a particular stimulus. Planar semiconductors can serve as the basis for many different types of sensor in which detection is monitored electrically and/or optically. For example, a planar field effect transistor (FET) can be configured for detecting the presence and/or concentration of charged chemical or biological species by modifying the gate oxide (without gate electrode) with molecular receptors or a selective membrane for the analyte of interest. Binding of a charged species then results in depletion or accumulation of carriers within the transistor structure.

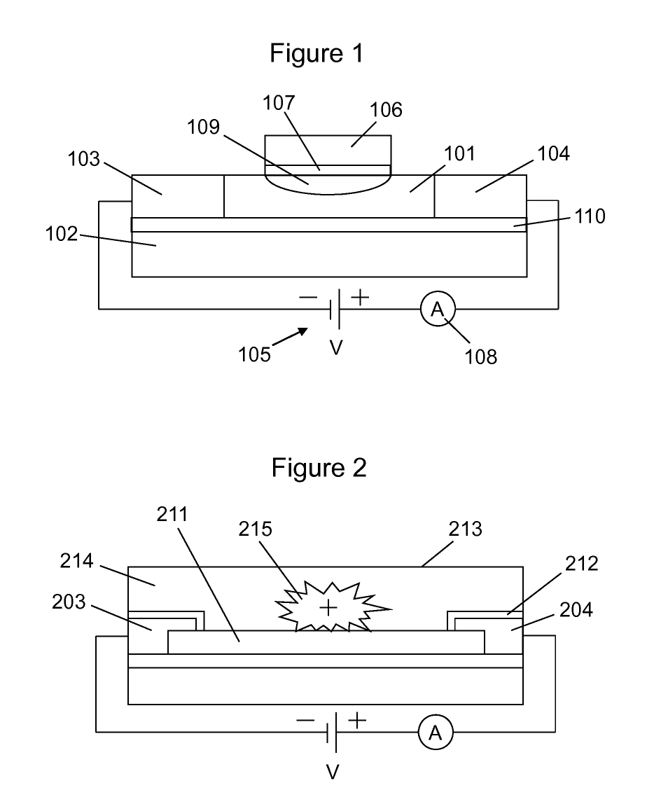

In a standard (planar) FET, as illustrated in FIG. 1, a semiconductor such as p-type silicon 101 is supported on a substrate 102 (coated with an electrically insulating layer 110) and connected to metal source 103 and drain 104 electrodes. A current is injected and collected via the source and drain electrodes, respectively, by applying a potential difference 105 across the semiconductor. The conductance of the semiconductor between the source and drain electrodes is switched on and off by a third electrode, the gate electrode 106, capacitively coupled through a thin dielectric layer 107. Conductance may be determined by measuring the current through the semiconductor (using an ammeter 108, for example) and dividing by the potential difference. With p-type silicon (or another p-type semiconductor), application of a positive gate voltage depletes charge carriers (creating a depletion region 109 in the semiconductor) and reduces the conductance, whilst applying a negative gate voltage leads to an accumulation of charge carriers (creating a conductive channel) and an increase in conductance. The dependence of conductance on gate voltage makes FETs natural candidates for electrically-based sensors since the electric field resulting from the binding of a charged species to the gate dielectric is analogous to applying a voltage using a gate electrode.

An attractive feature of such chemically sensitive FETs is that binding can be monitored by a direct change in conductance or related electrical property. However, planar FETs often suffer from low sensitivity as a result of their size, which is typically on the macro (mm) or micro (μm) scale.

The physical properties limiting sensor devices fabricated in planar semiconductors can readily be overcome by exploiting nanoscale FETs. In this regard, nanoscale sensors based on nanowires and nanotubes have received considerable recent attention. Nanowires and nanotubes have the potential for very high sensitivity (single-molecule detection in some cases) since the depletion or accumulation of charge carriers, which are caused by binding of a charged molecule at the surface of the nanowire/nanotube, can affect the entire cross-sectional conduction pathway of these nanostructures. Furthermore, the small size of the nanowires and nanotubes combined with recent advances in assembly suggest that dense arrays of sensors could be prepared.

In a nanowire FET, as illustrated in FIG. 2, the planar semiconductor is replaced by one or more nanowires 211 and the gate electrode is removed. A general sensing device can be configured where specific sensing is achieved by linking a recognition group to the surface of the nanowire. Silicon nanowires with their natural oxide coating make this receptor linkage straightforward, since extensive data exists for the chemical modification of silicon oxide or glass surfaces from knowledge of planar chemical and biological sensors. The sensor device illustrated further incorporates source 202 and drain 203 electrodes which are insulated from the environment by a dielectric coating 212 so that only those processes occurring at the nanowire surface contribute to the electrical signal.

Many sensor devices also incorporate a microfluidic system. Microfluidics is the science of designing, manufacturing and formulating devices and processes that deal with the behaviour, precise control and manipulation of fluids that have volumes on a sub-millilitre scale (microlitres, nanolitres or possibly even picolitres). The devices themselves have dimensions ranging from millimetres down to micrometers. The behaviour of fluids at this scale can differ from macrofluidic behaviour in that factors such as surface tension, energy dissipation and fluid resistance start to dominate the system. Microfluidic systems include a number of components (such as pumps, valves, seals and channels etc) specifically adapted to control such small volumes of fluid. Microfluidic systems have diverse and widespread potential applications. In particular, microfluidic biochips utilise microfluidic systems to integrate assay operations such as detection, as well as sample pre-treatment and sample preparation on a single chip. A microfluidic channel 213 for delivery of the solutions 214 being examined can be seen in FIG. 2.

When the sensor device with surface receptor is exposed to a solution containing an analyte molecule 215 that has a net positive charge in aqueous solution, specific binding causes an increase in the surface positive charge and a decrease in conductance for a p-type nanowire device. It is of course possible to form a sensing device using an n-type nanowire instead of a p-type nanowire.

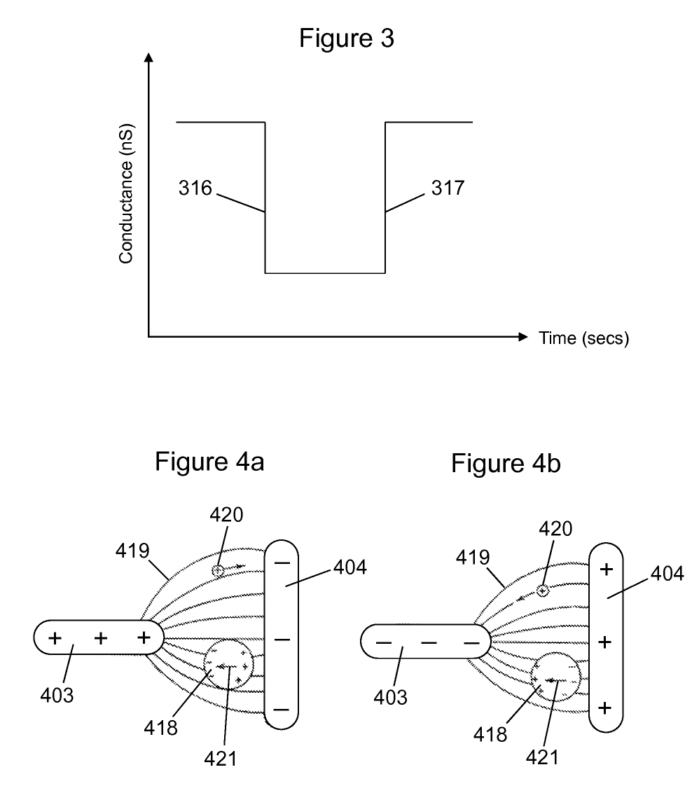

An example of a typical conductance versus time plot for a p-type nanowire sensor is given in FIG. 3, which shows a decrease in conductance 316 when an analyte molecule that has a net positive charge binds to the surface of the nanowire. Subsequent detachment of the analyte species then results in an increase in conductance 317 to the original value.

As mentioned earlier, the complexity, time and cost required to fabricate an array of nanowire sensing elements of different materials renders the production of context-aware sensing systems inefficient. There will now be described an apparatus and associated methods that may or may not overcome this issue.

How best to align nanowires is a key issue that needs to be addressed for the assembly of large scale integrated devices. A number of assembly methods have been devised, which include chemical selective deposition, fluidic alignment, atomic force microscope manipulation, optical assisted alignment, and electric dielectrophoresis. Of these methods, dielectrophoresis is most popular because of its ease in manipulation and high efficiency. To date, dielectrophoresis has been used to align carbon nanotubes (CNTs), gallium nitride nanowires, zinc oxide nanowires and many other inorganic nanomaterials as well as viruses and other biological matter.

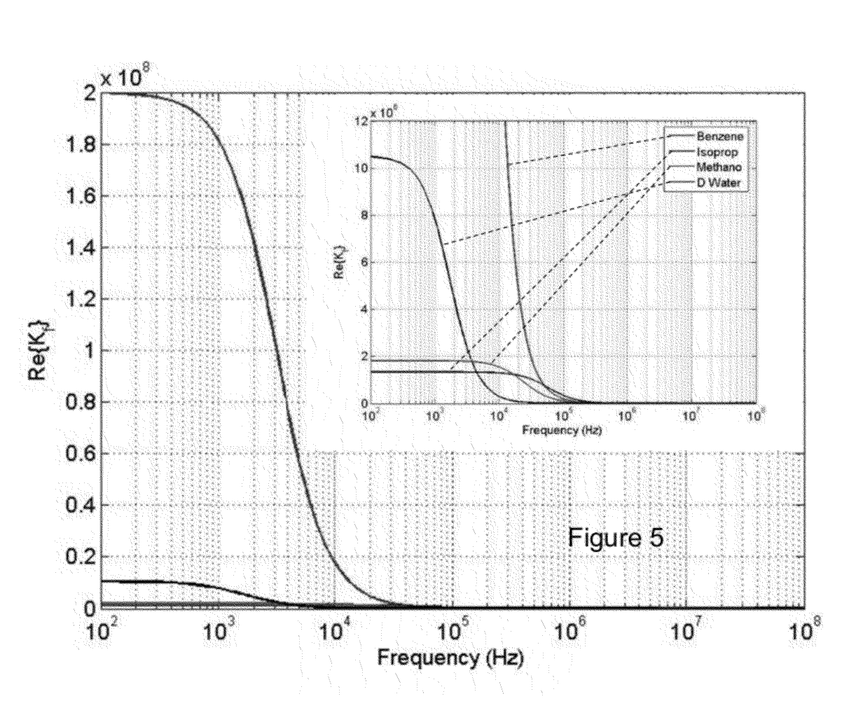

The term dielectrophoresis generally refers to the motion of particles 418 under the influence of a non-uniform electric field 419. When a suspension of particles 418 is positioned between two adjacent electrodes 403, 404 and an AC electric field 419 is applied, the electric field 419 polarises the particles 418 inducing effective dipole moments. If the particles 418 are more polarisable than the fluid medium 420, the particles 418 will be drawn towards the region of high electric field (known as positive dielectrophoresis), as illustrated in FIG. 4a. If, on the other hand, the particles 418 are less polarisable than the fluid medium 420, the particles 418 will be forced away from the region of high electric field by the fluid medium 420 (known as negative dielectrophoresis). The direction of force 421 (and consequently the direction of motion) remains constant when the AC field 419 reverses. This is because the dipole moment switches in response to the applied field 419, as illustrated in FIG. 4b.

The force experienced by a particle in solution as a result of a non-uniform electric field is given by

F_{DEP} (t)=(p(t).∇)E(t) (Equation 1)

where F_{DEP}(t) is the time dependant dielectrophoretic (DEP) force experienced by the particle, p(t) is the induce dipole moment vector, and E(t) is the time varying applied electric field.

The dipole moment of a body that is anisotropically, linearly and homogeneously polarisable depends on the applied electric field and is represented by

p(t)=VαE(t) with F_{DEP} (t)=Vα(E(t).∇)E(t) (Equation 2)

where V is the total volume of the particle, and α is the polarisability tensor for the particle. For a spherical particle, the time averaged F_{DEP} is given by

F_{DEP}=2πr³∈ₘ [symbol] [K(ω)]∇E² (Equation 3)

where r is the particle radius, ∈ₘ is the permittivity of the fluid medium, ∇ is the Del vector operator, E is the rms electric field, and [symbol] [K(ω)] is the real part of the Clausius-Mossotti factor (CMF), given by

$$K [ f ] = \frac{{ɛ}_{p}^{*} - {ɛ}_{m}^{*}}{{ɛ}_{p}^{*} + 2 {ɛ}_{m}^{*}} \qquad ( Equation 4 )$$

For a cylindrical particle of length l (which represents a nanowire sensing element), on the other hand,

$${F}_{DEP} = Γ {ɛ}_{m} ℜ [ K ( f ) ] ∇ {E}^{2} and K [ f ] = \frac{{ɛ}_{p}^{*} - {ɛ}_{m}^{*}}{{ɛ}_{m}^{*}} \qquad ( Equation 5 )$$

where Γ is a shape-dependent parameter given by

$$Γ = \frac{π {r}^{2} l}{6} \qquad ( Equation 6 )$$

and the complex permittivity is given by

$${ɛ}_{m , p}^{*} = {ɛ}_{m , p} - i \frac{{σ}_{m , p}}{ω} \qquad ( Equation 7 )$$

In Equation 7, ∈_{m,p} and σ_{m,p} are the real permittivity and the conductivity of the fluid medium medium/particle, respectively, and ω is the angular frequency of the AC field.

The sign of [symbol] [K(ω)] determines whether the dielectrophoresis will be positive (i.e. particles move to regions of higher electric field strength), or negative (i.e. particles move to regions of lower electric field strength).

For a cylindrical particle, the real part of the CMF is given by

$$ℜ [ K ( ω ) ] = \frac{{ω}^{2} {ɛ}_{m} ( {ɛ}_{p} - {ɛ}_{m} ) - {σ}_{m} ( {σ}_{m} - {σ}_{p} )}{{ω}^{2} {ɛ}_{m}^{2} + {σ}_{m}^{2}} \qquad ( Equation 8 )$$

As can be seen from Equation 8, the choice of fluid medium greatly affects the F_{DEP}. The table below gives textbook values for the relative dielectric constants along with the conductivity of different solvents that may be used for dispersing the nanowires.

| | Relative Dielectric | Conductivity |
|---|---|---|
| Medium | Constant εₘ/εₚ | σ (S/m) |
| DI Water | 80.0 | 7.6 × 10⁻⁶ |
| Methanol | 32.9 | 4.4 × 10⁻⁵ |
| Isopropanol (IPA) | 18.6 | 6.0 × 10⁻⁵ |
| Benzene | 2.3 | 4.0 × 10⁻⁷ |

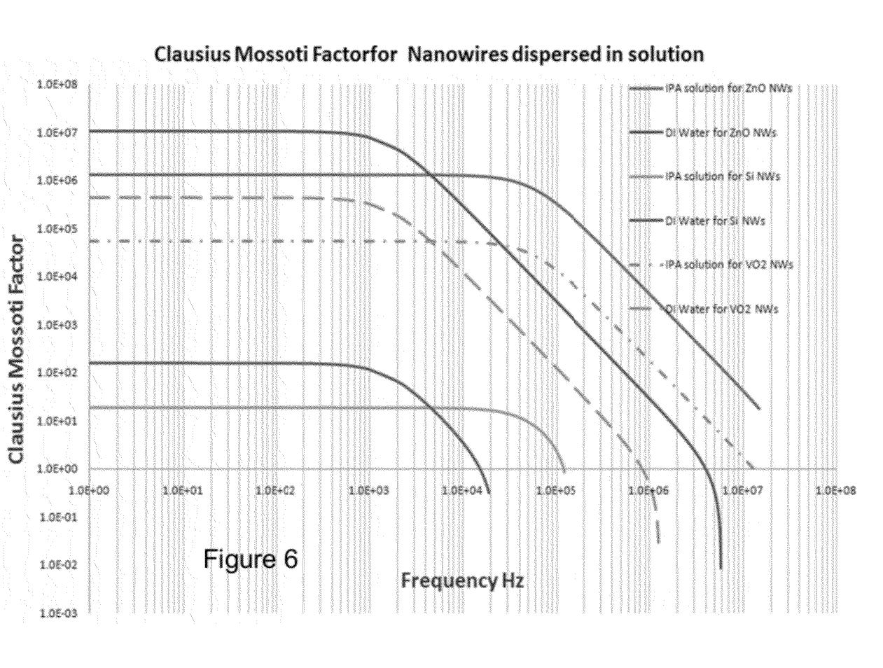

FIG. 5 illustrates how the CMF should vary with the frequency of applied field for a ZnO nanowire suspended in the four different solvents shown in the table above. For these calculations, the nanowire radius, length, conductivity and dielectric constant were set to 80 nm, 5 μm, 80 S/m and 9.12, respectively. From this graph, the cut-off frequency (i.e. the frequency at which the CMF starts to drop from its maximum value) is different for each solvent. The inset provides more detail at the lower end of the CMF scale.

FIG. 6 illustrates how the CMF should vary with the frequency of applied field for different nanowire materials (ZnO, Si and VO₂) suspended in both IPA and deionised water. For these calculations, the ZnO nanowire radius, length, conductivity and dielectric constant were set to 35 nm, 5 μm, 80 S/m and 9.12, respectively; the Si nanowire radius, length, conductivity and dielectric constant were set to 15 nm, 7 μm, 0.004 S/m and 4, respectively; and the VO₂ nanowire radius, length, conductivity and dielectric constant were set to 75 nm, 3 μm, 3.3 S/m and 18.3, respectively. From this graph, the cut-off frequency for each solvent is unaffected by the nanowire material.

FIGS. 5 and 6 show that the CMF has a constant maximum value at low frequencies, and that the CMF decays rapidly when the frequency reaches the cut-off point for a given fluid medium.

Since the F_{DEP} is directly proportional to the CMF, the alignment of any nanowires, nanotubes or nanoparticles between the electrodes should be greatest at low frequencies where the CMF is a maximum. However, our recent experimental results are inconsistent with this theory.

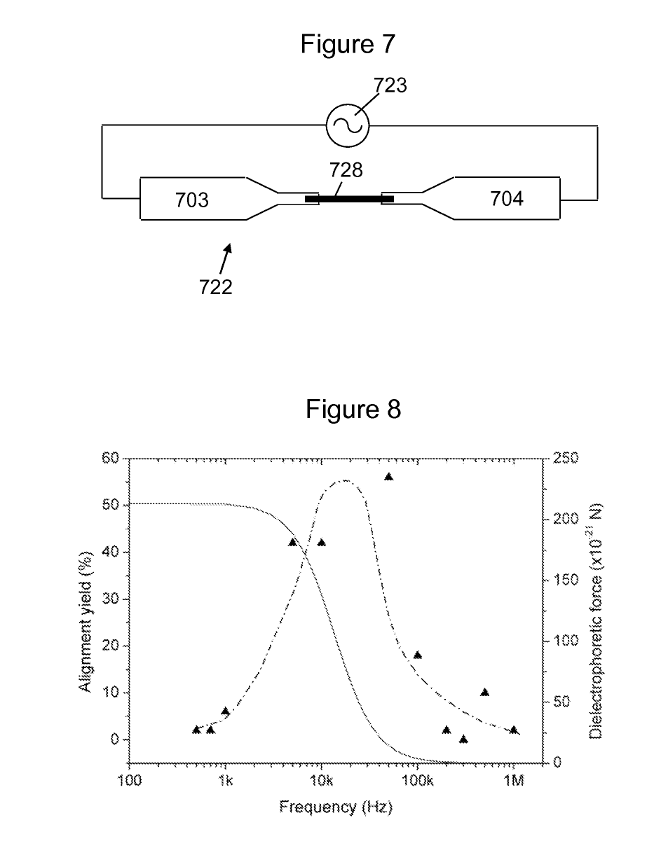

In a first experiment, ZnO nanowires 728 were suspended in IPA and exposed to an AC electric field. As illustrated in FIG. 7, the AC electric field was generated between an electrode pair 722 (comprising first 703 and second 704 electrodes of opposite polarity) by applying an alternating potential difference across the first 703 and second 704 electrodes using an AC signal generator 723.

The percentage of aligned nanowires 728 (i.e. those which were attracted from the fluid medium and captured in the gap between the metal electrodes 703,704) was plotted for different frequencies of applied field. The results are shown in FIG. 8. The right-hand y-axis shows the F_{DEP} intensity. As can be seen from this graph, the triangular data points (the dot-dash line serves as a guide for the eye) contradict with dielectrophoretic theory (solid line). Instead of increasing to a maximum value at low frequencies, the alignment yield peaked at around 20 kHz.

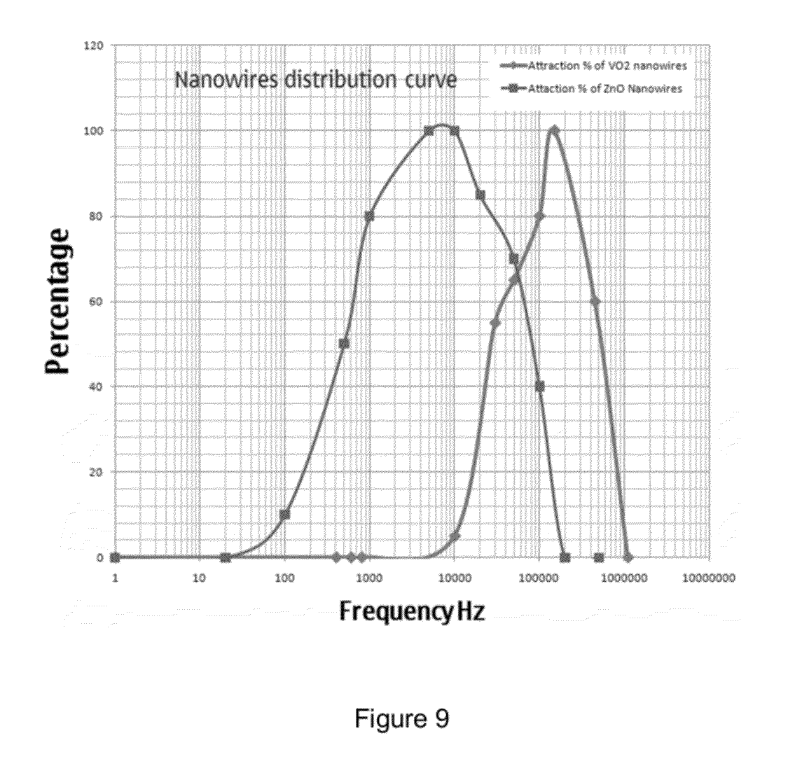

In a second experiment, a mixture of ZnO and VO₂ nanowires were suspended in deionised water and exposed to an AC field. Again, the percentage of aligned nanowires of each type was plotted for different frequencies of applied field. The results are shown in FIG. 9. The yield-frequency distributions reveal that the ZnO and VO₂ nanowires have different frequency dependencies: alignment of the ZnO nanowires peaked at around 5 kHz, whilst the alignment of the VO₂ nanowires peaked at around 150 kHz.

Whilst this behaviour is not completely understood, one theory for the decrease in yield at low frequencies is that ionic charge screening in the material may be reducing the effective dipole moment established in the nanowire. Regarding the yield offset, the only explanation so far is that the effect must be related to the inherent material properties.

If different nanowire materials have their own alignment fingerprint, this property could be exploited to align nanowires of different materials on the same supporting substrate from a single feedstock solution. An apparatus, fluid medium and method for achieving this will now be described.

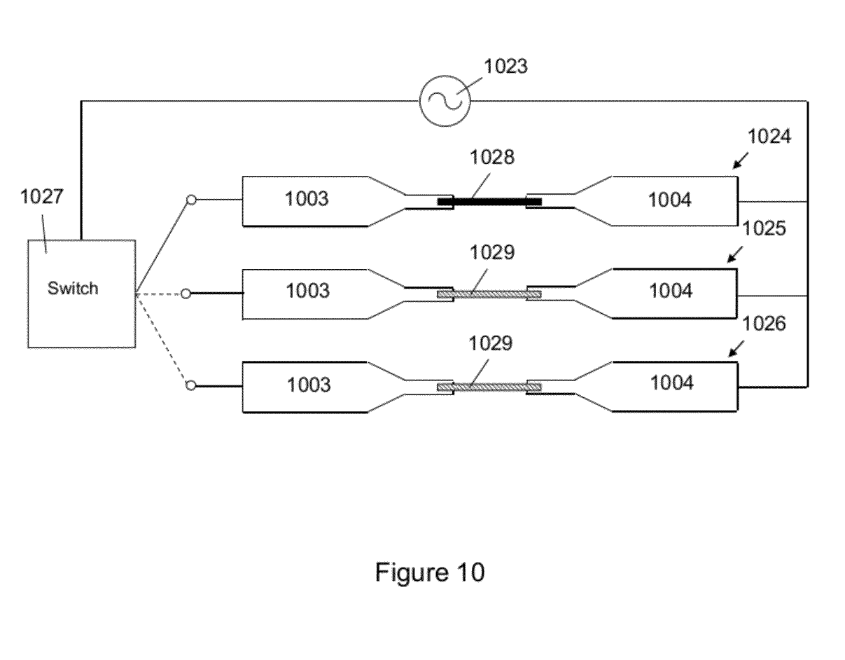

In a first embodiment, shown in FIG. 10, the apparatus comprises multiple electrode pairs 1024-1026, each electrode pair 1024-1026 configured for individual control. Whilst three electrode pairs 1024-1026 are shown in this figure, any number could be employed in practice. The electrode pairs 1024-1026 may be fabricated on a single supporting substrate or on separate supporting substrates using standard lithographic and deposition processes. In this embodiment, an AC signal generator 1023 is electrically connected to each electrode pair 1024-1026 by means of a switch 1027. In this way, the frequency and amplitude of field generated between the electrodes of each pair 1024-1026 may be different.

The fluid medium formed by dispersing multiple types (materials) of nanowire within a given solvent, and mixing the solution in an ultrasonic bath to produce a homogenous suspension of nanowires. The suspension may comprise a plurality of nanowires of each type. However, given that nanowires in suspension tend to aggregate after a few hours, the suspension may further comprise one or more surfactants to ensure that the nanowires remain evenly dispersed throughout the solvent. Each nanowire may be coated in a specific surfactant appropriate to the material from which the nanowire is made before being added to the solvent.

The nanowires themselves may be grown using a vapour-liquid-solid (VLS) mechanism or catalytic chemical vapour deposition (CVD) procedure. For example, arrays of single-crystalline ZnO nanowires can be grown using VLS in a vacuum deposition system with gold nanoparticles as catalysts on a GaN substrate. The growth of a crystal by direct adsorption of gas onto a solid surface is generally very slow. The VLS method circumvents this by introducing a catalytic liquid alloy which can rapidly adsorb a vapour to saturation levels, and from which crystal growth can subsequently occur from nucleated seeds at the liquid-solid interface. The physical characteristics of nanowires grown in this manner depend, in a controllable way, upon the size and physical properties of the liquid alloy. First, a thin layer (or particles) of gold is deposited onto the surface of the GaN substrate, typically by sputter deposition or thermal evaporation. The substrate is then annealed to create self-assembled liquid gold droplets. Lithography can be used to controllably manipulate the diameter and position of the droplets. Following this, Zn and O₂ are introduced to the system, which react to form a ZnO vapour. The Au droplets on the surface of the substrate act to lower the activation energy of normal vapour-solid growth, and absorb ZnO from the vapour state until reaching saturation. Since ZnO has a higher melting point than the ZnO—Au alloy, ZnO precipitates out of the saturated alloy droplet at the liquid-alloy/solid GaN interface in the form of a pillar-like structure. As the precipitation of ZnO continues, the height of the pillar increases, resulting in the formation of a ZnO nanowire. The Au droplet (nanoparticle) used to catalyse the process remains at the free end of the nanowire. The dimensions of the nanowires can be controlled to some degree, with diameters in the range of 50-300 nm and lengths in the range of 1-10 μm. Once grown, the nanowires can be added to the solvent.

The substrate on which the electrodes are fabricated (the supporting substrate) is then immersed in the fluid medium, and the AC signal generator 1023 (which may be computer controlled) is used to create a non-uniform alternating electric field between the first 1003 and second 1004 electrodes of each electrode pair 1024-1026. In the example described herein, the fluid medium comprises a mixture of nanowires “A” 1028 and “B” 1029, each type of nanowire 1028, 1029 comprising a different material. The electrode pairs 1024-1026 are denoted “A”, “B” and “C”, respectively. Electrode pair A 1024 is used to align the A-type nanowires 1028, electrode pair B 1025 is used to align the B-type nanowires 1029, and electrode pair C 1026 is used to align both A-type 1028 and B-type 1029 nanowires.

By setting the frequency of electrode pair A 1024 to a value corresponding to the peak yield of nanowires A 1028, the A-type nanowires 1028 experience the maximum F_{DEP} and are attracted towards electrode pair A 1024 from the suspension. Meanwhile, the B-type nanowires 1029 experience a smaller F_{DEP} and are not attracted to electrode pair A 1024 (or are less strongly attracted). As a result of the field pattern generated by the first 1003 and second 1004 electrodes, the A-type nanowires 1028 are positioned across the first 1003 and second 1004 electrodes of electrode pair A 1024, thereby forming an electrical connection. In this way, an electrical current can be passed from the first electrode 1003, through the A-type nanowire 1028, to the second electrode 1004 for subsequent sensing of one or more stimuli. Likewise, by setting the frequency of electrode pair B 1025 to a value corresponding to the peak yield of nanowires B 1029, the B-type nanowires 1029 experience the maximum F_{DEP} and are attracted towards electrode pair B 1025 from the suspension. Meanwhile, the A-type nanowires 1028 experience a smaller F_{DEP} and are not attracted to electrode pair B 1025 (or are less strongly attracted). Again, the B-type nanowires 1029 are positioned such that they are electrically connected between the first 1003 and second 1004 electrodes of electrode pair B 1025.

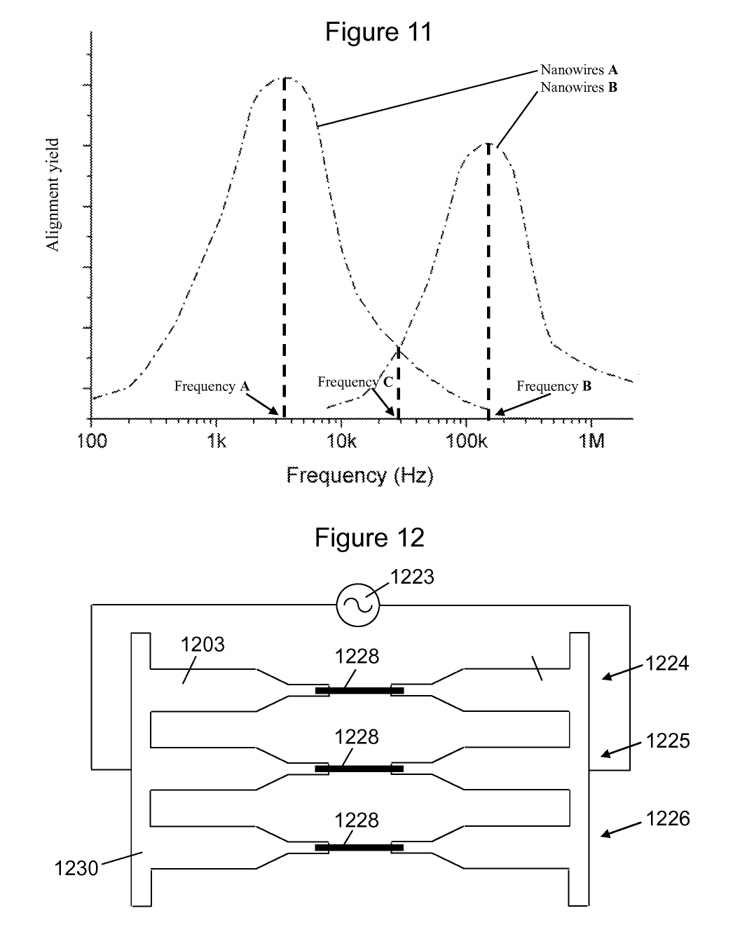

If the yield-frequency distributions for nanowires A 1028 and B 1029 overlap with one another, electrode pair C 1026 may be set to generate an alternating electric field at a frequency which lies somewhere between the values corresponding to the peak yields of nanowires A 1028 and B 1029. In this way the probability of aligning each type of nanowire 1028, 1029 will depend on how far the frequency is from the peak frequency. For example, if the frequency is set to a value exactly between the peak values of nanowires A 1028 and B 1029, there is a 50% chance of aligning each type of nanowire 1028, 1029 between the first 1003 and second 1004 electrodes of electrode pair C 1026. The closer the frequency is to the peak value of nanowires A 1028 or B 1029, the greater than chance of aligning that particular type of nanowire between the first 1003 and second 1004 electrodes of electrode pair C 1026. FIG. 11 shows how the alignment yield of each type of nanowire 1028, 1029 varies with the frequency of applied field.

In this embodiment, the mere detection of an electrical current flowing between the first 1003 and second 1004 electrodes of an electrode pair 1024-1026 could be used to determine whether or not a nanowire 1028, 1029 has been aligned between the first 1003 and second 1004 electrodes. In the event that a nanowire 1028, 1029 has not yet been aligned, it may be necessary to mix or agitate the suspension of nanowires, apply the electric field for a longer period of time, and/or check to make sure that the applied field conditions are correct for that particular material. Furthermore, given that electrical conductivity varies with material, a measure of conductance could be used to determine exactly which type of nanowire 1028, 1029 has been aligned between a particular electrode pair 1024-1026. This may be useful if the frequency has been set to attract more than one type of nanowire material. To achieve this, a known potential difference is applied across the first 1003 and second 1004 electrodes and the current through the nanowire 1028, 1029 measured. With these values, the conductivity can then be determined by dividing the current by the potential difference.

Once the nanowires have been aligned between the electrodes and the supporting substrate has been removed from the fluid medium, a layer of material may be deposited on top of the nanowires to hold them in position. This helps to maintain the electrical connection, and may be particularly important if the sensors form part of a portable device, or if the sensors will be used to detect analytes in solution. In these scenarios, movement of the device or forces associated with the flow of fluid may be sufficient to disturb the nanowire alignment unless they are bound to the electrodes. If the layer of material is deposited over the whole supporting substrate, then the material must be electrically insulating to prevent the electrodes from being short circuited. If, on the other hand, the layer of material is patterned such that it is not in physical contact with both the first and second electrodes of an electrode pair, then electrically conducting or non-conducting materials may be used. In this scenario, any metal may be suitable for holding the nanowires in position.

In another embodiment, shown in FIG. 12, multiple electrode pairs 1224-1226 are physically and electrically connected to form electrode units 1230. In this embodiment, the electrode pairs 1224-1226 of each electrode unit 1230 are configured for simultaneous control, such that an AC signal generator 1223 may be used to apply the same potential difference to all electrode pairs 1224-1226 of that electrode unit 1230 at the same time. This configuration provides a greater number of potential alignment sites for the nanowires 1228, and therefore increases the chances of successfully forming an operational sensor. Whilst a detection of current flow could be used to determine whether or not any nanowires 1228 have been aligned between one or more electrodes pairs 1224-1226 in that unit 1230, further analysis (e.g. using microscopy) would be required to determine which electrode pairs 1224-1226 have a nanowire 1228 aligned between them and which do not. Furthermore, given that different types of nanowire 1228 could be positioned at different electrode pairs 1224-1226 of the same unit 1230 at the same time (e.g. if the frequency has been set to attract more than one type of nanowire material), it would be difficult to determine the number and type of aligned nanowires using conductance measurements because the reading would be averaged over all of the aligned nanowires 1228. Nevertheless, this may be possible if the conductance could be measured accurately enough.

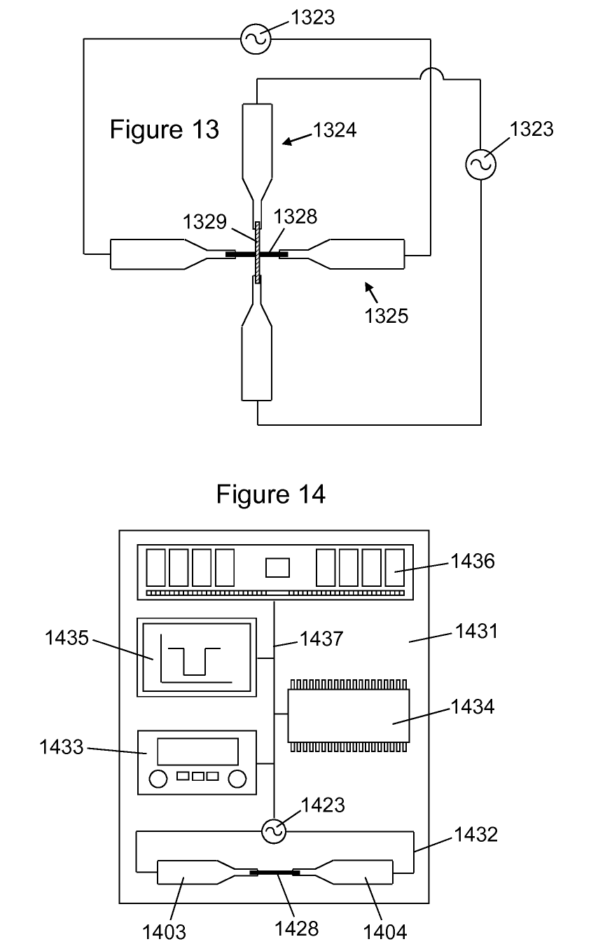

Another embodiment is illustrated in FIG. 13. This embodiment comprises at least two electrode pairs 1324, 1325 arranged in a cross-bar configuration. For simplicity, only two pairs have been shown, but the configuration could be expanded in two or three dimensions to produce a grid-like array. Each of the electrode pairs 1324, 1325 may be individually addressable. This may be achieved using separate AC signal generators 1323 as shown, or using one AC signal generator 1323 connected to both electrode pair 1324, 1325 by means of a switch. Alternatively, the electrode pairs 1324, 1325 could be simultaneously addressable using multiple connections to the same AC signal generator 1323. This embodiment increases the packing density of the nanowire sensors compared to the previously described embodiments, although it may be necessary to deposit a layer of insulating material on top of the bottom nanowire 1328 before alignment of the top nanowire 1329 to prevent a cross flow of current during subsequent detection experiments.

FIG. 14 illustrates schematically a device 1431 comprising the apparatus 1432 described herein. The device further comprises a measurement apparatus 1433, a processor 1434, a display apparatus 1435 and a storage medium 1436, which may be electrically connected to one another by a data bus 1437. The device 1431 may further comprise a microfluidic channel (not shown) to contain the fluid medium, and a microfluidic device (not shown) for delivery of the fluid medium. The device 1431 may be a portable electronic device or a module for a portable electronic device.

The measurement apparatus 1433 is used to apply a potential difference across the electrodes 1403, 1404, measure the current through the nanowires 1428, and determine the conductance or other electrical property of the nanowire 1428. The AC signal generator 1423 and measurement apparatus 1433 may be removably connected to the electrodes 1403, 1404 by electrical connectors (although in other embodiments they may be non-releasably connected, e.g. hard-wired). The removable connections allow the supporting substrate to be disconnected and physically removed from the other device components for modification, replacement or additional processing. This is particularly important if a layer of material needs to be deposited on the supporting substrate after alignment of the nanowires 1428.

The processor 1434 is configured for general operation of the device 1431 by providing signalling to, and receiving signalling from, the other device components to manage their operation. In particular, the processor 1434 receives electrical data during testing and sensing experiments, and processes the data for display on the display apparatus 1435. This allows the electrical response of each nanowire 1428 to be observed visually. The processor 1434 may also process the electrical data to determine the presence and quantity of stimuli during use of the nanowire sensors. This may be achieved by comparing the electrical data with data previously stored in a database to determine a match. On the other hand, the processor 1434 may simply pass the electrical data to the display apparatus 1435 for manual analysis.

The storage medium 1436 is configured to store computer code required to make the apparatus 1432, as described with reference to FIG. 16. The storage medium 1436 may also be configured to store specific settings for the other device components to enable the processor 1434 to manage their operation. In particular, the storage medium 1436 may be used to store the electric field frequencies for operation of the electrodes 1403, 1404. The storage medium 1436 may also be used to store the electrical data captured during testing and sensing experiments, as well as the database used to determine a match with the electrical data. The storage medium 1436 may be a temporary storage medium such as a volatile random access memory, or may be a permanent storage medium such as a hard disk drive, flash memory or non-volatile random access memory.

If the AC signal generator 1423 and measurement apparatus 1433 are removably coupled (although not just limited to this circumstance) to the apparatus 1432, it is possible to supply a kit comprising the patterned electrode configuration 1403, 1404 (on the supporting substrate) together with the fluid medium (e.g. the suspension of various types of nanowire within a solvent). Where the apparatus 1432 is to be used for sensing the presence and/or concentration of one or more chemical or biological species, it may be useful to supply a control amount of these species to confirm that the formed apparatus 1432 is capable of detecting such species. Furthermore, the fluid medium could be supplied separately from the electrodes 1403, 1404, AC signal generator 1423 and measurement apparatus 1433.

The apparatus 1432 may be incorporated within a microfluidic system (not shown) so that liquid can only follow prescribed routes to and from the nanowire sensing elements 1428. The microfluidic system may comprise sample inlets, solution reservoirs, microchannels, waste reservoirs and, if required, pumping mechanisms. The exact architecture will vary depending on the particular species involved, as well as the specific electrode configuration. Each nanowire 1428 may be individually addressable, and hence operated in isolation from any other nanowires 1428 in terms of both the microfluidics and the electronic control mechanisms. Alternatively, several nanowires 1428 may be simultaneously addressable, and hence operated in unison with other nanowires 1428 in terms of both the microfluidics and the electronic control mechanisms. Each nanowire 1428 may be connected to a microchannel comprising an inlet and an outlet for delivering solutions. To simplify waste removal, the solution in the microchannel may be configured to flow in one direction from the inlet to the outlet.

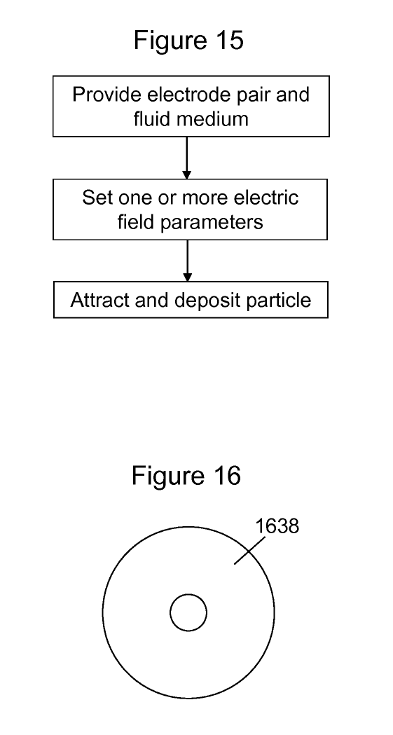

The key stages of the deposition method described herein are illustrated schematically in FIG. 15. In particular, the method involves: providing an electrode pair and a fluid medium, the electrode pair comprising first and second electrodes configured to generate an alternating electric field therebetween, the fluid medium comprising a plurality of different types of particle dispersed therein; and setting one or more parameters of the alternating electric field to attract at least one type of particle from the fluid medium towards the electrode pair and deposit said at least one type of particle.

FIG. 16 illustrates schematically a computer/processor readable medium 1638 providing a computer program according to one embodiment. In this example, the computer/processor readable medium 1638 is a disc such as a digital versatile disc (DVD) or a compact disc (CD). In other example embodiments, the computer/processor readable medium 1638 may be any medium that has been programmed in such a way as to carry out an inventive function. The computer/processor readable medium 1638 may be a removable memory device such as a memory stick or memory card (SD, mini SD or micro SD).

The computer program is configured for controlling deposition using an electrode pair and a fluid medium, the electrode pair comprising first and second electrodes configured to generate an alternating electric field therebetween, the fluid medium comprising a plurality of different types of particle dispersed therein, the computer program comprising code configured to set one or more parameters of the alternating electric field to attract at least one type of particle from the fluid medium towards the electrode pair and deposit said at least one type of particle.

As mentioned previously, the method, fluid medium and computer program described herein could be applied to any application that requires the deposition of a particular type of material from a single feedstock solution comprising a plurality of different types of material.

On a general level, the method, fluid medium and computer program could be used to assemble networks composed of functional elements out of solution. For instance, if the solution comprises both metallic particles and semiconducting particles, it would be possible to selectively deposit the semiconducting particles to serve as functional elements, and to selectively deposit the metallic particles to serve as interconnecting elements. In this way, the metallic particles could be used to connect the functional elements to form operational circuits (such as amplifier circuits or logic circuits) on the supporting substrate.

Some or all of the semiconducting particles may comprise a p-n junction, or may form a p-n junction with the supporting substrate. Such p-n junctions may be suitable for the generation of electromagnetic radiation (including visible light). Other particles in the fluid medium may be used as waveguides. This embodiment could therefore be used to form an optoelectronic circuit.

In these embodiments, the electrodes used for deposition of the particles may also be used for operation of the functional elements. In such cases, sufficient electrical contact between the electrodes and functional elements is required.

It will be appreciated to the skilled reader that any mentioned apparatus/device and/or other features of particular mentioned apparatus/device may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some example embodiments, a particular mentioned apparatus/device may be pre-programmed with the appropriate software to carry out desired operations, and wherein the appropriate software can be enabled for use by a user downloading a “key”, for example, to unlock/enable the software and its associated functionality. Advantages associated with such example embodiments can include a reduced requirement to download data when further functionality is required for a device, and this can be useful in examples where a device is perceived to have sufficient capacity to store such pre-programmed software for functionality that may not be enabled by a user.

It will be appreciated that the any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some example embodiments one or more of any mentioned processors may be distributed over a plurality of devices. The same or different processor/processing elements may perform one or more functions described herein.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed example aspects/embodiments may consist of any such individual feature or combination of features. In view of the foregoing description it will be evident to a person skilled in the art that various modifications may be made within the scope of the disclosure.

While there have been shown and described and pointed out fundamental novel features as applied to different example embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. A method of deposition, the method comprising:
providing an electrode pair and a fluid medium,
the electrode pair comprising first and second electrodes configured to generate an alternating electric field therebetween,
the fluid medium comprising a plurality of different types of particle dispersed therein; and
setting one or more parameters of the alternating electric field to attract at least one type of particle from the fluid medium towards the electrode pair and deposit said at least one type of particle.

2. The method of claim 1, the method comprising setting the one or more parameters of the alternating electric field to attract more than one type of particle for deposition.

3. The method of claim 2, the method comprising setting the one or more parameters of the alternating electric field to control the probability of depositing each type of particle.

4. The method of claim 1, the method comprising providing multiple electrode pairs configured for individual control, and setting the respective electric field parameters associated with at least two electrode pairs to deposit a different type of particle between the first and second electrodes of each of the at least two electrode pairs.

5. The method of claim 4, the method comprising providing the multiple electrode pairs in a cross-bar configuration.

6. The method of claim 1, the method comprising providing multiple electrode pairs configured for simultaneous control as an electrode unit, and setting the electric field parameters associated with the electrode unit to deposit the same type of particle between the first and second electrodes of each electrode pair.

7. The method of claim 1, the method comprising depositing a layer of material on top of the deposited particles.

8. The method of claim 1, wherein two or more types of particle each comprise a different material.

9. The method of claim 1, wherein the particles comprise nanowires or nanotubes.

10. The method of claim 1, the method comprising removing the electrode pair after deposition of the at least one type of particle.

11. The method of claim 1, wherein the particles are sensing elements.

12. The method of claim 11, wherein each type of sensing element is suitable for sensing a respective stimulus from the surrounding environment when electrically connected between the first and second electrodes of the electrode pair, and wherein the at least one type of sensing element is deposited such that it is electrically connected between the first and second electrodes of the electrode pair.

13. The method of claim 12, wherein two or more types of sensing element are suitable for sensing the same stimulus.

14. The method of claim 13, wherein at least two of the two or more types of sensing element have a distinct sensitivity profile for said stimulus.

15. The method of claim 13, wherein the sensitivity profile of at least one of the two or more types of sensing element overlaps with the sensitivity profile of another of the two or more types of sensing element.

16. The method of claim 12, wherein at least one type of sensing element is suitable for sensing one or more of the following stimuli: the presence and/or concentration of a chemical species, the presence and/or concentration of a biological species, temperature, pH, and electromagnetic radiation.

17. The method of claim 1, wherein the at least one type of deposited particle forms part of an apparatus.

18. The method of claim 17, wherein the apparatus is one or more of the following: a sensor apparatus, a portable electronic device, and a module for a portable electronic device.

19. The method of claim 1, wherein the parameters of the alternating electric field are one or both of frequency and amplitude.

20. A fluid medium comprising a plurality of different types of particle dispersed therein, wherein each type of particle is suitable for deposition under particular electric field conditions of an alternating electric field generated between first and second electrodes of an electrode pair.

21. A computer program for controlling deposition using an electrode pair and a fluid medium,
the electrode pair comprising first and second electrodes configured to generate an alternating electric field therebetween,
the fluid medium comprising a plurality of different types of particle dispersed therein,
the computer program comprising code configured to set one or more parameters of the alternating electric field to attract at least one type of particle from the fluid medium towards the electrode pair and deposit said at least one type of particle.
